(19) United States
(12) Patent Application Publication
(10) Pub. No.: US 2011/0024248 A1
(43) Pub. Date: Feb. 3, 2011

(54) Piston seal element and retardation device with piston seal element

(76) Inventors: Günther Zimmer, Rheinau (DE); Martin Zimmer, Rheinau (DE)

Correspondence Address: KLAUS J. BACH, 4407 TWIN OAKS DRIVE, MURRYSVILLE, PA, 15668, US

(21) Appl. No.: 12/806,675

(22) Filed: Aug. 18, 2010

Related U.S. Application Data
(63) Continuation-in-part of application No. PCT/DE2009/000242, filed on Feb. 23, 2009.

(30) Foreign Application Priority Data
Feb. 25, 2008 (DE) 10 2008 010 908.8

(51) Int. Cl. F16F 9/36; F16J 15/16

(52) U.S. Cl. 188/322.16; 277/460

(57) ABSTRACT

In a piston seal element and a deceleration structure including a piston seal element which has a deformation area delimited in the longitudinal direction of the seal element by frontal face areas and a sleeve surface area with at least one channel extending between the two frontal face areas, the channel extends screw thread-like around the seal element between the frontal face areas thereof.

This is a continuation-in-part application of pending international patent Application PCT/DE2009/000242 filed Feb. 23, 2009 and claiming the priority of German patent application 10 2008 010 908.8 filed Feb. 23, 2008.

### BACKGROUND OF THE INVENTION

The invention resides in a piston seal element with at least one sleeve-like deformation area which, in the longitudinal direction of the piston seal element, is delimited by two end face areas and which has a surface area with a channel extending between the two end face areas and a retardation device including such a piston seal element.

DE 102 14 596 A1 discloses for example a piston seal element. Its use in a deceleration device results in rapid deceleration. However, the effectiveness of the piston seal element depends on the ambient temperature.

It is therefore the object of the present invention to provide a piston seal element which is highly effective and its effectiveness is largely independent of the ambient temperature.

### SUMMARY OF THE INVENTION

In a piston seal element and a deceleration structure including a piston seal element which has a deformation area delimited in the longitudinal direction of the seal element by end face areas and a sleeve surface area with at least one channel extending between the two end face areas, the channel extends screw-thread-like around the seal element between the end face areas thereof.

The invention will become more readily apparent from the following description of a particular embodiment thereof with reference to the accompanying drawings.

### BRIEF DESCRIPTION OF THE DRAWINGS

FIG. 1 shows an acceleration and deceleration device in a park position,

FIG. 2 shows the acceleration and deceleration device in an end position remote from the park position,

FIG. 3 is a detail view of a part of the acceleration and deceleration device,

FIG. 4 shows a seal element,

FIG. 5 shows the seal element of FIG. 4 in an axial cross-sectional view,

FIG. 6 shows the seal element in a transverse cross-sectional view, and

FIG. 7 shows a part of the seal element with an integrated sealing lip.

### DESCRIPTION OF A PARTICULAR EMBODIMENT

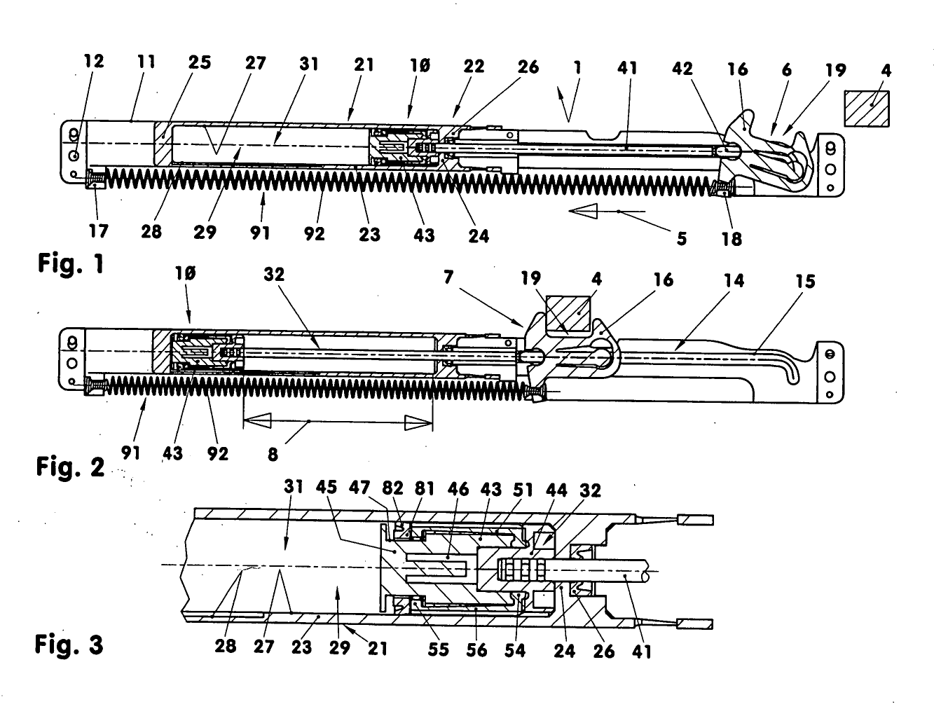

FIGS. 1 and 2 show a combined deceleration and acceleration device 10 including a carrier element 16 in a park position 6, see FIG. 1 and in an end position 7, see FIG. 2.

The combined deceleration and acceleration device shown is for example part of a guide system, for example, a drawer guide structure of a furniture piece or a sliding door arrangement. In such a guide system, the combined deceleration and acceleration device 10 is for example mounted to a furniture component relative to which a furniture drawer is movable. The drawer is provided with an operating element 4 which comes into contact with the carrier element 16 during closing of the drawer for example, more specifically during part of the closing movement of the carrier element 16 near the end position of the deceleration and acceleration device 10. The operating element 4 enters the carrier element opening 19 and causes the release of the carrier element 16 from a force- and/or form-locked park position 6 and moves it in the closing direction 5 along a guide structure 14 to the end position 7. In the process, the slide movement of the drawer relative to the furniture piece is retarded by the retardation structures 21. For example, concurrently with the release of the carrier element 16 from its park position 6, the acceleration structure 91 is activated which pulls the drawer against the effect of the deceleration structure 21 for example into the closed end position. The deceleration and acceleration device 10 remains in engagement with the operating element 4 of the drawer until the drawer reaches its closed end position, for example. Of course, such a retardation and acceleration device 10 may also be used during opening of the drawer such that its movement is controlled for reaching the open end position of the drawer.

The deceleration and acceleration device 10 comprises a base component 11 on which the deceleration structure 21, the acceleration structure 91, the guide structure 14 and the carrier element 16 are arranged.

The base component 11 has for example six throughbores 12 for mounting the deceleration and acceleration device for example to a piece of furniture by means of mounting devices.

For example, the pneumatic deceleration structure 21 comprises a cylinder-piston unit 22 with a cylinder 23 and a piston 43 with a piston rod 41 movably disposed in the cylinder 23. The piston and the piston rod may be made integrally so that they form a piston-piston rod unit. The piston rod has a head 42 to which the carrier element 16 is pivotally connected. The pivot axis extends in the representation of FIGS. 1 and 2 normal to the plane of the drawings.

FIG. 3 shows a detail of the retardation structure 21. The cylinder 23 has for example a cylinder cross-section 29 which becomes smaller toward the closed cylinder bottom end 25 and whose maximum diameter is for example 9 mm. The inner cylinder wall 27 which delimits the cylinder space 29 in radial direction has for example a longitudinal groove 28 which extends from the cylinder bottom 25 over 55% of the length of the cylinder interior 29. The longitudinal groove 28 has for example a constant width and its groove bottom extends for example parallel to the center axis of the cylinder 23. The cross-section 29 of the cylinder 23 decreases for example toward the cylinder bottom 25. However, the cross-section of the cylinder may also be constant over its length or it may increase toward the cylinder bottom 25. The cylinder 23 may furthermore have a rectangular, a square, an elliptical or a polygon-shaped cross-section. The cylinder head 24 is sealed at the piston rod 41 by means of a piston rod seal 26.

The piston 43 comprises for example a piston bottom 44 into which the piston rod 41 is inserted and cemented and a piston head part 45 which is disposed on a cylindrical central extension of the piston bottom part 44 and is cemented thereto. In the exemplary embodiment, an open space 46 is formed in the piston head part 45 into which for example during joining of the two piston parts 44, 45 the air is displaced.

The piston 43 is provided with two piston seal elements 51, 81. A first sleeve-like seal element 51 is disposed between the two piston parts 44, 45 where it is engaged in an engagement area 54 in a form-locking manner so as to be firmly retained. The second piston seal element 81 is for example a shaft seal ring 81 which is disposed in annular groove 47 of the piston head part 45 at the end of the first seal element 51 remote from the engagement area 54. The shaft seal ring 81 has an outer seal lip 82 which faces in a direction away from piston rod 41 and is in contact with the inner cylinder wall 27 at least in the piston shown in FIGS. 1 and 3.

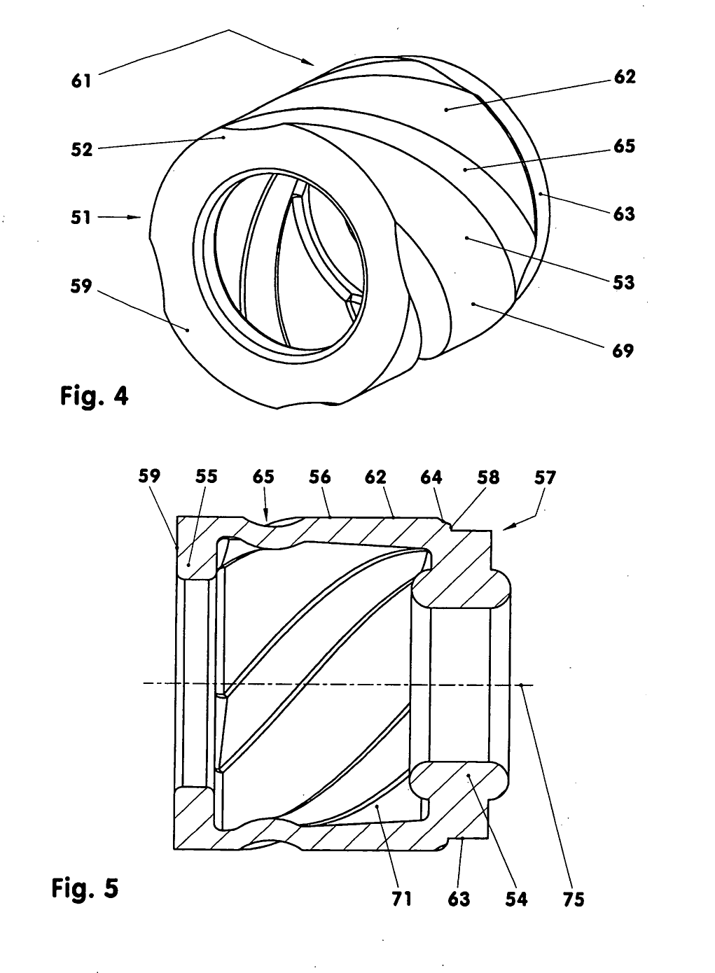

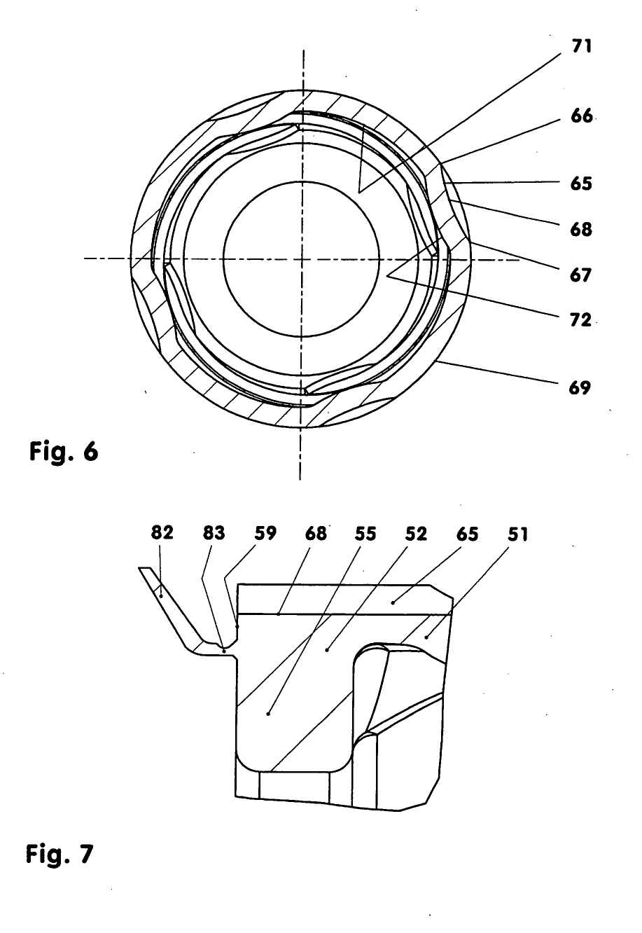

FIGS. 4-6 show the first piston seal element 51. FIG. 4 is a perspective view and FIG. 5 is an axial cross-sectional view of the seal element 51.

The piston seal element 51 as shown herein has a length of 8.5 mm and a maximum diameter of 8.65 mm. Adjacent the engagement area 54, it has a cylindrical section 56 and an inner shoulder 55. The inner diameter in the engagement area 54 is four millimeters. The wall thickness of the cylindrical section 56 becomes smaller from the shoulder 55 toward the engagement area 54. Its minimum thickness is half a millimeter.

The piston seal element 51 consists for example of a nitrile-butadiene-caoutshouc having a hardness of for example 70 Shore. It may be provided with a halogenized surface. The material is to a large extent incompressible. This means that, upon deformations of the material, the volume of the piston seal element 51 remains mostly unchanged.

The outer surface 61 of the piston seal element 5 comprises a cylindrical surface area 63 and a sleeve surface area 62. The two surface areas 63, 62 are joined via a frontal transition area 58. The edge 64 between the sleeve surface area 62 and the frontal transition area 58 is for example inclined. In an embodiment of the piston seal element 51 without cylindrical surface area 63—for example, with only a sleeve surface area 62—the frontal transition area 58 is part of the front face 57 of the engagement area 54 of the piston seal element 51. The sleeve surface area 62 is delimited at the inner shoulder 55 by the front face 59 of the inner shoulder 55 of the piston seal element 51. Also, the front face 59 may include several sections which are distinct from one another.

The sleeve surface area 62 of the piston seal element 51 comprises at least one screw-like curved channel 65, four channels being shown in the exemplary embodiment. Between the channels 65 webs 69 are arranged. Each channel 65 interconnects the two areas 58, 59 which delimit the sleeve surface area 62. The screw-like wound channels 65 have a constant pitch in the exemplary embodiment and extend with respect to the two areas 58, 59 at an angle of 45°. This angle may be between 15 and 75°. The screw-like wound channels may also have a varying pitch. Also, an individual channel may at least have screw-like wound channel sections. In other exemplary embodiments, the channels may have sections which extend parallel or transverse to the longitudinal direction of the piston element 51. The two transition or limitation areas 58, 59 may be areas of intersecting planes. The said angle is then formed between the screw-like wound line of the channel and at least one of the surface areas 58, 59.

The channels 65 have for example a circle segment shaped cross-section with a radius of for example one millimeter. The individual channel 65 is for example 0.25 mm deep and has a width at its upper edge of 1.25 mm. The width of the channel is for example at least four times its depth. The minimum wall thickness of the piston seal element 51 is at least one and a half time the channel depth and maximally three times the channel depth. The cross-sectional area of a channel 65 is in this exemplary embodiment at least approximately twice the cross-section segment between the outer circumferential surface area of the piston seal element 51 and a secant the extending through the oppositely disposed channel edges 66, 67. The outer surface is herein the cylindrical surface which adjacent the wall 69 of the outer surface area 62 which, as shown in the exemplary embodiment, is ideally cylindrical.

The length of the channel base 68 in transverse direction corresponds at least approximately to the length of the imaginary sleeve circle arc of the piston seal element 51. In the exemplary embodiment, the area content of the sleeve surface area 62 around the channels 65 and the area content of the imaginary outer surface are at least approximately equal. In this connection, “at least approximately” means that the values compared with each other may deviate by +/−three percent. In this way, the area content of the cross-sectional area of the channel 63 may be between 197% and 203% of the area content of a cross-section segment of the virtual outer surface area of the piston seal element 51.

In each cross-section, the piston seal element 31 has a constant wall thickness. In the area of the channels 65 projections 72 are formed on the inner side 71 of the piston seal element 51.

The two surface areas 58, 59, which delimit the outer sleeve surface area 62 in an axial direction of the piston seal element 51, define a deformation area 53 of the piston seal element 51. When engaged in the engagement area 54, the piston seal element 51 is deformed mainly in this deformation area 53 in a radial, axial and/or torsional way.

The piston seal element 51 may comprise a seal lip 82. FIG. 7 shows such a seal element 51 in detail. At the face 59 of the inner shoulder 55, the base body 52 of the piston seal element 51, a flexible sealing lip 82, which projects outwardly at an angle, is molded onto the seal element 51 by means of a film hinge 83. The diameter of the film hinge 83 is smaller than a circle defined by the channel base 68. With such an embodiment of the first piston seal element 51, the second piston seal element 81 is not needed.

In the representation of FIGS. 1 and 2, the acceleration structure 91 is arranged below the deceleration structure 21. The deceleration structure includes an energy storage device 92, for example a tension spring 92. The latter is for example supported on the carrier element 16 and the base component 11 in spring holders 17, 18.

After assembly of the deceleration and acceleration device 10, the piston 43 and the cylinder bottom 25 delimit in the shown exemplary embodiment a displacement chamber 31. The piston 43 and the piston rod seal 26 delimit a compensation chamber 32. The stroke 8 of the piston 43 and the piston rod 41 is for example 43 mm.

When the drawer is open the deceleration and acceleration device 10 is for example not in engagement with the operating element 4. The carrier element 16 is locked and pivoted by 20° into its park position 6. The piston rod 41 is extended. The tension spring 92 is tensioned.

During closing of the drawer, the operating element 4 comes into contact with the carrier element 16 before the drawer reaches its closed end position. The operating element 4 abuts in the process the engagement shoulder of the carrier element 16 which is oriented in direction of the cylinder 23. The carrier element 16 is pulled thereby out of its park position 6 and pivoted into a position parallel to the piston rod 41. The operating element 4 locks onto the carrier element 16 and moves it along the guide structure 14 toward the end position 7.

The piston rod 41 of the pneumatic deceleration structure 21 is moved by the external force into the cylinder 23 in the direction as indicated by the arrow 5. The piston 43 is moved by the piston rod end 24 toward the cylinder bottom 25. In the process, the volume of the displacement chamber 31 is reduced. The gas pressure or air pressure in the displacement chamber 31 is increased thereby and acts as internal force on the piston seal element 51. From the beginning of the inward movement of the piston rod 41, the seal ring 81 is pressed with its sealing lip 82 onto the cylinder inner wall 27. The displacement chamber 31 and the compensation chamber 32 are quasi-hermetically isolated from each other. At the same time, a low pressure vacuum with respect to the ambient 1 is generated in the compensation chamber 32 which, in the shown embodiment, is isolated from the ambient, whereby the sealing effect of the sealing ring 81 is supported.

The pressure which is built up in the displacement chamber 31 is also effective on the deformation area 53 of the piston seal element 51. The latter is supported both, at the inner shoulder 55 and in the engagement area 54. By the application of pressure generated in the displacement chamber 31 to the large inner surface 71 the seal element 51 arches radially outwardly. The maximum outward displacement occurs for example in the center area of the deformation area 53. During movement of the piston 43 out of its end position at the cylinder head side of the displacement chamber 31, the deformation area 53 abuts radially the inner wall 27 of the cylinder 23. Upon further movement of the piston rod 41, the piston seal element 51, which is now pressed against the inner cylinder wall 27, the cylindrical section 56 acts as a braking sleeve 51 resulting in a high deceleration of the piston movement. The movement of the drawer accordingly is strongly slowed down by means of the deceleration structure 21.

During the deformation of the deformation area 53, the piston seal element is axially shortened whereby the braking effect is increased. The channels 65 which are curved around the piston seal element 51 in a screw-like fashion result in a deformation which is greater than that of a seal element with a comparable number of annular channels extending in the longitudinal direction. With the reduced spring rigidity, the piston seal element 51 presented herein will respond more rapidly and is therefore more effective than a seal element with channels extending parallel to its longitudinal axis. The braking effect occurs suddenly. It is also possible that the piston element 51 is twisted in the process whereby it becomes subject to an additional deformation process. With a loose engagement of the engagement area 54, the whole piston seal element 51 may be rotated about its longitudinal axis 75.

The geometric design of the piston seal element 51 provides for a reliable operation of the deceleration structure 21 also at low temperatures. In this way, also in the temperature range of the glass transition temperature of the material of the piston seal element 51—with nitrile-butadiene-caoutshouc, this is for example 8° C.—a noticeable deceleration is safely achieved.

As soon as the piston seal element 51 has passed the edge of the longitudinal groove 28, air is discharged from the displacement chamber 31 via the throttle channel 28 and along the channels 65 into the compensation chamber 32. The pressure in the displacement channel 31 now drops for example suddenly. The piston seal element 51 may still abut the inner cylinder wall 27 or it may return to its original position before the start of the stroke movement.

With increasing stroke length of the piston rod 41 and the increasing cylinder cross-section, the engagement area of the seal lips 82 and of the deformation area 33 with the cylinder wall 27 decreases. The outward force caused by the gas pressure in the displacement chamber 31 on the cylinder wall decreases and, consequently, the deceleration of the stroke movement caused by the friction also decreases.

As soon as the seal lip 82 is no longer in contact with the inner wall 27 of the cylinder, additional air flows out of the displacement chamber 31 into the compensation chamber 32. The pressure in the displacement chamber now drops for example suddenly. The piston seal element may still abut the inner cylinder wall 27 or it may return to its original position before the start of the stroke movement

With increasing stroke length of the piston rod 41 and the increasing cylinder cross-section, the engagement area of the seal lip 82 and of the deformation area 33 with the cylinder wall 27 decreases. The outward force caused by the gas pressure in the displacement chamber 31 on the cylinder wall decreases. And, consequently, the deceleration of the stroke movement caused by the friction also decreases.

As soon as the seal lip 82 is no longer in contact with the inner wall of the cylinder, additional air flows out of the displacement chamber 31 into the compensation chamber 32. The seal ring now assumes again its original position, it had at the beginning of the stroke movement. The piston seal element 51 may still be in contact with the inner cylinder wall 27 where the air flows during the stroke movement through the channels 65. During the further movement of the piston rod 41, the piston seal element 51 disconnects completely from the inner cylinder wall 27 and assumes its original position and shape. During the process, the screw-line-like formed channels 65, which are pulled during the piston movement in axial direction along the inner wall of the cylinder 27, prevent a sticking of the webs 69 to the cylinder wall 27. In this way, a safe release of the piston seal element 51 from the cylinder wall 27 is ensured independently of the temperature and/or the moisture content of the gas in the cylinder interior space 29.

In connection with a piston element 51 with an integrated seal lip 82, the release of the piston seal element 51 from the cylinder wall 27 occurs the same way as described above.

During the stroke movement of the piston rod 41, the tension spring 92 is relaxed. The acceleration structure 91 results in an acceleration force applied to the carrier element 16 caused by the discharge of the energy storage device 92, that is, the tension spring. At the beginning of the stroke movement, that is when the carrier leaves its park position 6, the deceleration force of the deceleration structure 91 is larger than the acceleration force caused by the spring 92. However, the deceleration force of the tension spring 92 decreases for example linearly with the stroke.

The drawer then moves slowly with little deceleration to its end position. There, it remains in place without rebound. The tension spring 92 has now only a small residual tension.

When the drawer is again pulled out, air flows mostly uninhibited from the compensation chamber 32 via the longitudinal grooves 28 and the chamber 65 into the displacement chamber 31. The piston seal elements 51, 81 remain at least essentially undeformed. The pull-out movement occurs therefore at least almost without any resistance. Only the spring 92 is again tensioned during outward movement of the drawer that is the energy storage device is again charged.

As soon as the piston rod 41 is completely pulled out of the cylinder 23, the carrier element 16 is again engaged in the park position 6. The piston rod seal 26 compensates for a slight pivot movement of the piston rod 41 so that the cylinder 23 remains sealed in any piston position. In this position, the operating element 4 is released from the carrier element 16. The deceleration and acceleration device 10 is disengaged.

The exemplary embodiments described above may also be combined. Also, the use of the piston seal element 51 in a deceleration structure 21 alone is feasible.

Listing of reference numerals

| | |
|---|---|
| 1 | Ambient |
| 4 | Operating element |
| 5 | Closing direction |
| 6 | Park position |
| 7 | End position |
| 8 | Stroke |
| 10 | Deceleration and acceleration device |
| 11 | Base component |
| 12 | Throughbores |
| 14 | Guide structure |
| 16 | Carrier element |
| 17, 18 | Spring holder |
| 19 | Carrier element opening |
| 21 | Retardation structure |
| 22 | Cylinder - piston unit |
| 23 | Cylinder |
| 24 | Cylinder head |
| 25 | Cylinder bottom |
| 26 | Piston rod seal |
| 27 | Inner cylinder wall |
| 28 | Longitudinal groove |
| 29 | Cylinder cross-section, space |
| 31 | Displacement chamber |
| 32 | Compensation chamber |
| 41 | Piston rod |
| 42 | Piston rod head |
| 43 | Piston |
| 44 | Piston bottom part |
| 45 | Piston head part |
| 46 | Open space |
| 47 | Annular groove |
| 51 | Piston seal element |
| 52 | Base body |
| 53 | Deformation area |
| 54 | Engagement area |
| 55 | Inner shoulder |
| 56 | Cylinder section |
| 57 | Front face |
| 58 | Frontal transition area |
| 59 | Front face |
| 61 | Center surface area |
| 62 | Sleeve surface area |
| 63 | Cylinder surface area |
| 64 | Edge |
| 65 | Curved channels |
| 66, 67 | Channel edges |
| 68 | Channel base |
| 69 | Webs |
| 71 | Inner side |
| 72 | Projection |
| 75 | Longitudinal axis |
| 81 | Piston seal element (ring) |
| 82 | Seal lip |
| 83 | Film hinge |
| 91 | Acceleration structure |
| 92 | Energy storage device |

What is claimed is:

1. A piston seal element (51) including a deformation area (53) delimited, in a longitudinal direction of the seal element (51), by two frontal face areas (58, 59), and having a sleeve surface area (62) provided with at least one channel (65) extending between the two frontal face areas (58, 59), said channel (65) being, at least in sections thereof, extending screw thread-like around the seal element (51).

2. The piston seal element according to claim 1, wherein the at least one channel (65) extends screw-thread-like around the seal element (51) over the full length thereof.

3. The piston seal element according to claim 1, the piston seal element (51) has a minimal wall thickness which is at least one and a half and maximally three times the depth of the channel (65).

4. The piston seal element according to claim 1, wherein the sleeve surface area (62) of the piston seal element (51) is at least approximately equal the surface area of the outer surface area thereof.

5. The piston seal element according to claim 1, wherein the sleeve surface area (62) includes at least four channels (65) which have all the same pitch.

6. The piston seal element according to claim 1, wherein the width of the channels (65) is at least five times their depth.

7. The piston seal element according to claim 1, wherein at least one of the frontal areas (58, 59) extends normal to the longitudinal axis (75) of the piston seal element (51).

8. The piston seal element according to claim 7, wherein the channels (65) extending screw thread line like around the seal element (51) extend from the frontal area (58, 57) at an angle of 45°.

9. The piston seal element according to claim 1, wherein one of the frontal areas (59) is provided with a seal lip (82).

10. A deceleration structure (21) including a cylinder-piston unit (22) with a piston (43) provided with a piston seal element (51), including a deformation area (53) delimited in a longitudinal direction of the seal element (51) by two frontal face areas (58, 59), and having a sleeve surface area (62) provided with at least one channel (65) extending between the two frontal face areas (58, 59), said channel (65) extending, at least in sections thereof, screw thread-like around the seal element (51).
